(19) United States
(12) Patent Application Publication
(10) Pub. No.: US 2008/0077443 A1
(43) Pub. Date: Mar. 27, 2008

(54) Medical record coding and audit system

(76) Inventor: Benjamin D. Singer, Chicago, IL (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/527,291

(22) Filed: Sep. 26, 2006

(51) Int. Cl. G06F 19/00

(52) U.S. Cl. 705/3

(57) ABSTRACT

A method and system of processing medical records includes providing an image of a medical record on a screen and inputting a code associated with a portion of the medical record. A region of the medical record is selected that supports the code and the selected region of said medical record is visibly marked and associated with the code. The code and associated selected region of the medical record are stored for subsequent retrieval. The method and system can also enable opening the medical record and displaying at least one code associated with the medical record and displaying the stored selected region of the medical record associated with the code. Plural codes may be selected for a medical record with each code being associated with at least one of a plurality of selected regions of the medical record.

### FIELD OF THE INVENTION

The present invention relates generally to medical record coding and audit systems and more particularly to a patient medical record coding system with tracking capability for the medical record coding audit process.

### BACKGROUND OF THE INVENTION

Currently, hospitals (and other medical facilities, clinics, and the like) recover costs for the services provided by processing a patient's medical record after he or she is discharged from the hospital or a procedure is completed. With hospitals it is when the patient is sent home or transferred. Hospitals collect all the forms, notes, orders, test results, and other documentation for a patient and gather them in the records room. After this, the record is presented to a coder. Based on the material in the medical record, the coder generates the diagnostic and procedure codes required by third party insurance companies, Medicare and Medicaid. To do this, the coder may use either the original paper medical record or its imaged (scanned) replica or the record data in a medical record system.

As the coder reads and locates specific information statements in the patients' medical record, they assign codes. These codes are captured on paper or into a computer system. The coding capture system may be handwriting on paper, or it may be keyed into software that is stand alone or integrated with the other coding or medical record systems. When the coding is complete, the codes are saved appended to the medical record and passed to the billing department. These systems may employ an imaged or databased medical record storage and display program. These programs are known and offered in the market, for example, by McKesson as the Horizon patient folder or by Cerner in large integrated hospital systems. Coding assistant systems and also known and offered in the market, for example, by 3M Corporation in medical record encoder software.

The process of coding is prone to error. There are many reasons. Coders read a large volume of records that are routine. However, a small number such records may contain very small differences, but differences that change the coding. The medical documentation is often handwritten leading to lower legibility or, at times, incompleteness. Certain parts of the record may not be available at the time of coding, like a discharge summary. Codes and the regulations for coding are regularly reviewed and changed. The changes may occur, for example, quarterly. New procedures, drugs, and disease categories can evolve ahead of the codes to describe them. A main coding job productivity metric is volume of medical records processed. This metric pushes coders to work quickly and may increase errors.

Systems have been developed to enhance the accuracy of the coding of medical records. One such system is described in U.S. Patent Publication No. 2005/0251422A1 for SYSTEM AND METHOD FOR NEAR REAL-TIME CODING OF HOSPITAL BILLING RECORDS. In that system a method is employed that facilitates communications between doctors and coders to resolve coding problems pertaining to medical records. The method involves near real time communications between doctors and hospital personnel to resolve patient documentation issues. The method involves providing an imaged replica of a paper medical record that is being prepared by one or more doctors to one or more hospital personnel while the paper record is being prepared by the doctor; receiving by the hospital personnel the imaged replica; and reviewing by the hospital personnel the imaged replica so that the hospital personnel may determine whether or not the doctor provided sufficient information on the medical record for the hospital personnel to accurately code the medical record.

To evaluate the accuracy of the coding, samples of medical records are re-coded by individuals that are not the original coder and may also have expertise in the review of coding of medical records. This recoding is a medical record audit. These audits are usually done on only a subset of the coded records since the re-coding process is time consuming and costly.

While it is possible for the auditor to see the codes that the original coder has chosen, they can not see the coders work, as such, and do not know what exactly the coder was looking at when code assignment was made. This makes it hard, in the event of an error, to know the nature of the error, and/or to correct the error, to reconcile differences and/or to inform the coder for learning and correction. It also makes it hard to review large number of coded records for compliance with regulations about required medical documentation to support the coding. These regulations can change multiple times a year and can requiring changes in the audit process.

### SUMMARY OF THE INVENTION

It is an object of the present invention to provide an enhanced system for the coding of medical records.

It is a further object of the present invention to provide an enhanced system for medical record coding that facilitates the audit of the original medical record coding.

It is yet another object of the present invention to reduce the amount of material that needs to be reviewed during and audit of medical record coding.

A method of processing medical records embodying the present invention includes the steps of providing an image of a medical record on a screen and inputting a code associated with a portion of the medical record. A first region of the medical record is selected that supports the code and the selected first region of the medical record is visibly marked and associated with the code. The code and associated selected first region of the medical record are stored for subsequent retrieval.

A method of processing medical records also embodying the present invention includes the steps of providing an image of a medical record on a screen and inputting a plurality of codes each code being associated with a portion of the medical record. A plurality of regions of the medical record are selected that support each of the plurality of codes. Each of the selected plurality of regions of the medical record is visibly marked. Each of said plurality of codes are stored and associated with at least one of the selected plurality of visibly marked regions of said medical record for subsequent retrieval.

A medical records coding and audit system embodying the present invention includes a computing system having a medical records application, a coding application and an audit application. The computing system further includes a medical records database, a captured codes database and an audit trail database. A display is coupled to the computing system for displaying medical records and displaying coding capture fields. The medical records application, the coding application the audit application, the medical records database, the captured codes database and the audit trail database are operably connected to enable regions of a medical record displayed on the display to be visibly marked and associated with an entered code in the coding capture fields and stored for subsequent retrieval in the computing system.

### DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention. As shown throughout the drawings, like reference numerals designate like or corresponding parts in the various figures.

FIG. 1 is a block diagram of a medical record coding and audit system embodying the present invention and having a medical records application, a coding application and a audit trail application;

FIG. 2 is illustration of an example of what a coder or auditor would see on a computer screen that is coupled to operate with the medical record coding and audit with three windows open, one for each of the three applications that are part of the system;

FIG. 3 is a flow chart of the code capture process, which includes the placement of the visible marker in the medical record as well as the storage of the information associated with such code; and,

FIG. 4 is a flow chart of the audit process where a code can be backtracked to the original content in the medical record associated with the code assignment.

### DETAILED DESCRIPTION OF THE PREFERRED EMBODIMENT

In describing the present invention, reference is made to the drawings, wherein reference numerals designate like or corresponding parts

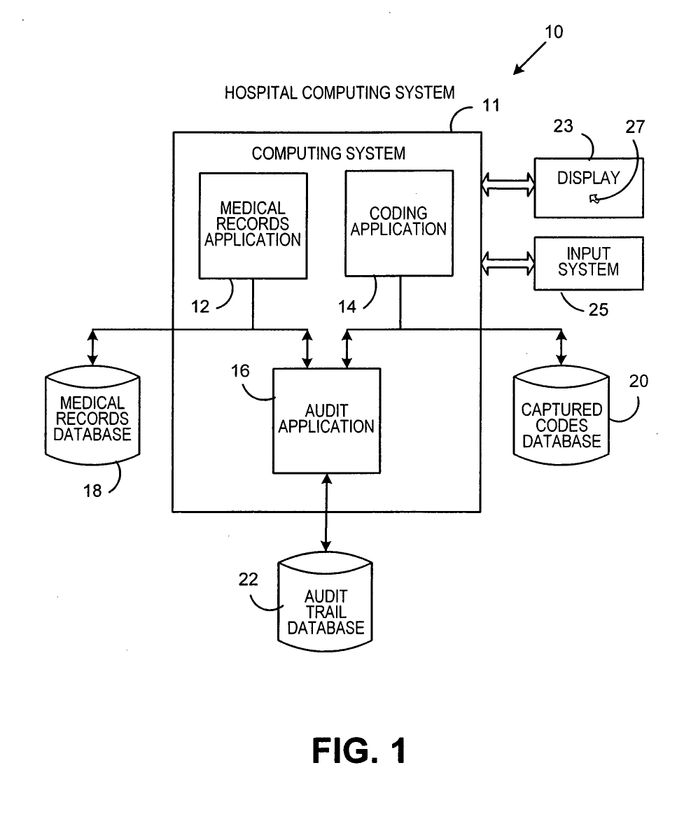

Reference is now made to FIG. 1. A hospital computing system 10 includes a computing system 11 with three separate applications, a medical records application 12, a coding application 14 and an audit trail application 16. The hospital computing system 10 further includes a medical records database 18, a captured codes database 20 and an audit trail database 22. The various applications cooperate to enable medical records to be coded for billing and other purposes with the results stored and the results subsequently audited for accuracy or other purposes. The hospital computing system 10 also includes a computer screen or display 23 and an input system 25 for use by the coders and/or auditors. The input system 25 enables the user to move a cursor 27 to various positions on the screen 23 to allow the input and retrieval of data such as text and codes in the proper fields and the visible marking of various regions of displayed medical record regions. The hospital computing system 10 can be organized and implemented in many different ways to provide the relationships for proper operation of the system.

The relationships between the various applications and databases are such that the medical record viewer is a data base viewing system that lets the coder/medical record reader look at the medical records stored in the medical record data base. This relationship consists of a request for certain pages of the record and then the organization of that data for display. There, of course, can be other more complicated functions if desired. The primary relationship of the coding system is that it may include its own library of codes and coding rules, and its store of the codes created for each coded patient medical record. This data could be stored in the medical record data base also and, even if the codes are stored separately, they may also be stored as part of the complete medical record in the medical data base. Thus the coding system is connected via the audit application to the medical records application and is also connected to the coding data base. The audit application needs to be able to know when a code was entered in the coding system and to save its own copy of the code as well as some reference to the portion(s) of the medical record that were employed to justify the code assignment. That is why the audit application is connected to the coding system and part of the reason the audit system is connected to the medical record system. When the audit process happens, the audit software needs a way to tell the medical record system to fetch and display the part of the record associated with the code. The communication of this command, as well as the ability to display the markers or other form of highlighting, is the another reason the audit application is connected to the medical record application.

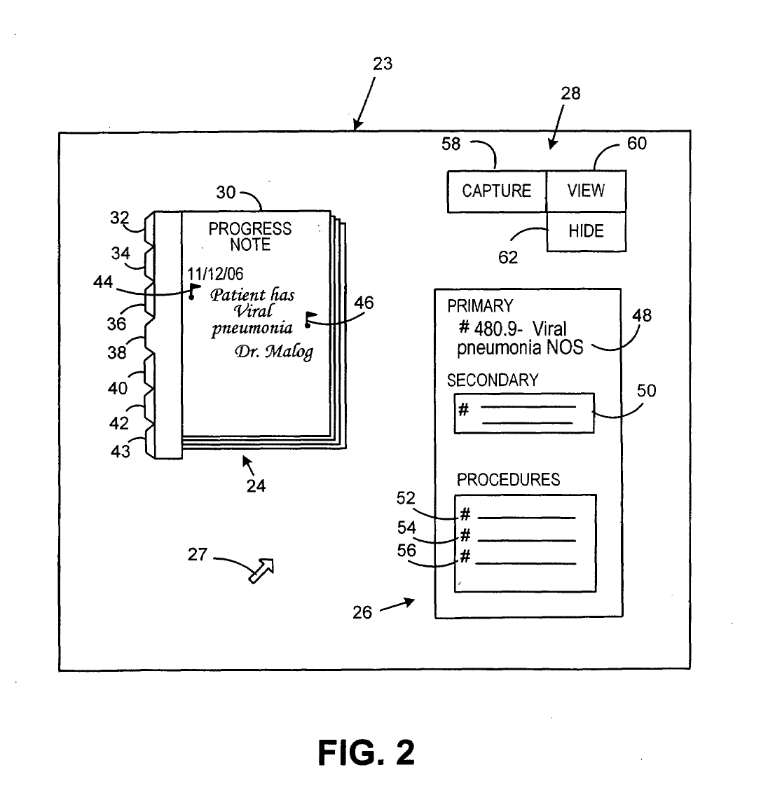

Reference is now made to FIG. 2, which is a representation of an image that a coder and an auditor may view on a computer screen during the process of coding and/or auditing a medical or hospital record. The screen or display 23 has three windows open, showing three separate applications. The first application is a medical record viewing application shown generally as 24, the second application is a coding capture application shown generally as 26, and the third application is an audit tracking application shown generally as 28.

The medical record viewing application 24 may be any of a number of various applications, which allows a display on a screen of medical records associated with a patient. The particular record portion being displayed at 30 are progress notes by a doctor. A series of tabs 32, 34, 36, 38, 40 42 and 43 allow the coder or auditor using the system to display different portions of the medical record. A visible marker, here flags, have been placed on the progress note comment field stating, “patient has Viral Pneumonia” The flagging of this portion is denoted by a starting flag 44 and an ending flag 46, such that the beginning and ending of the particular portion is flagged for later utilization. The portion is also show as being highlighted.

The second application, the coding capture application 26, allows the coder (or auditor, should the auditor be using the system) to apply various codes to the medical record. For example, a primary diagnosis code is available for entry at field 48 showing “480.9 viral pneumonia NOS”, a secondary diagnosis code is available at field 50, as well as various procedure codes for entry at fields 52, 54 and 56. NOS stands for “Not Otherwise Specified.” The codes that are entered are based on information obtained by the coder or auditor from information displayed on the screen 23 by the medical records viewing application 24. At a subsequent point in time, an audit can be conducted of the coding of the medical record. The auditor may implement this by bringing up the medical record through the viewing application 24 for a particular record or a portion of a record such as the progress notes to be audited for proper coding. The auditor can bring up the appropriate medical record either with the visible marking and/or the associated codes in plain view or hidden on the medical record being reviewed.

The audit tracking application 28 allows capture at 58 of the various codes that have been entered by the original coder, as well as the associated medical record portions for the particular code, as denoted by the various flags. For example, if a primary diagnosis at field 48 is a code for “patient has viral pneumonia,” that code at field 48 would be related to the patient record progress note portion flagged at 44 through 46. The same is true in connection with the secondary codes and the various procedure codes that may be applied to any portion of the medical record.

When an auditor is recoding a patient record, the auditor has an option, as previously noted, to either view the portion that is associated with a particular code by clicking the screen cursor 27 on the screen button VIEW 60 or, if desired, to hide that information at by clicking the cursor 27 on the screen button HIDE 62 so as to re-code without seeing how original codes were applied by the coder. When auditing a record, the auditor can look at the previously assigned codes, and if the auditor selects any code, such as with cursor 27, the medical record viewing system will reveal the page and markers that go with that code.

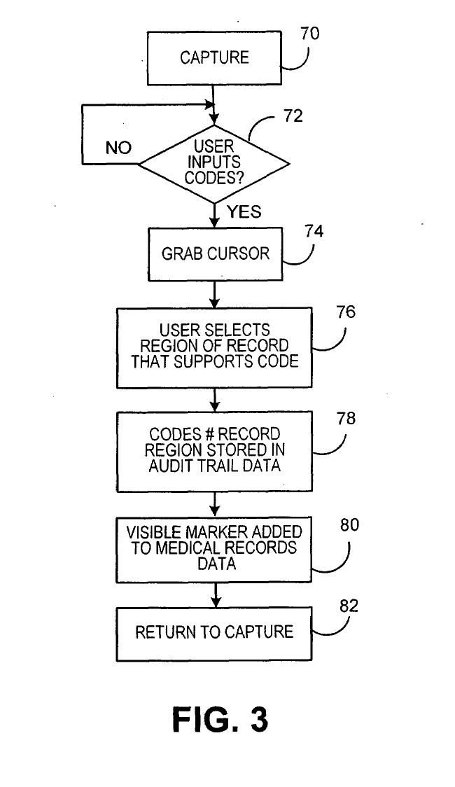

Reference is now made to FIG. 3. The coding of a medical record begins at 70. A use, coder or auditor, of the system determines whether a code is to be input at decision box 72. If no code is input at decision box 72, the system loops back to the input to decision box 72. However, if a code is input by the user at decision box 72, the cursor 27 on screen 23 is grabbed at 74 by the user and the user selects and marks the region of the record that supports the particular code at 76. Various marking systems can be employed such as flagging, highlighting, underlining, bolding, italicizing, etc. The code and the associated flagged region of the medical record are stored in the audit trail database at 78. The visible marker is added to the medical record's database at 80. The system returns to the capture mode at 82 and the process begins again at box 70. The flow inter-relates the various three systems in the operation of the hospital records system shown in FIG. 3, the coding application at 72, the audit application at 74, 76 and 78, and the medical records application at 80.

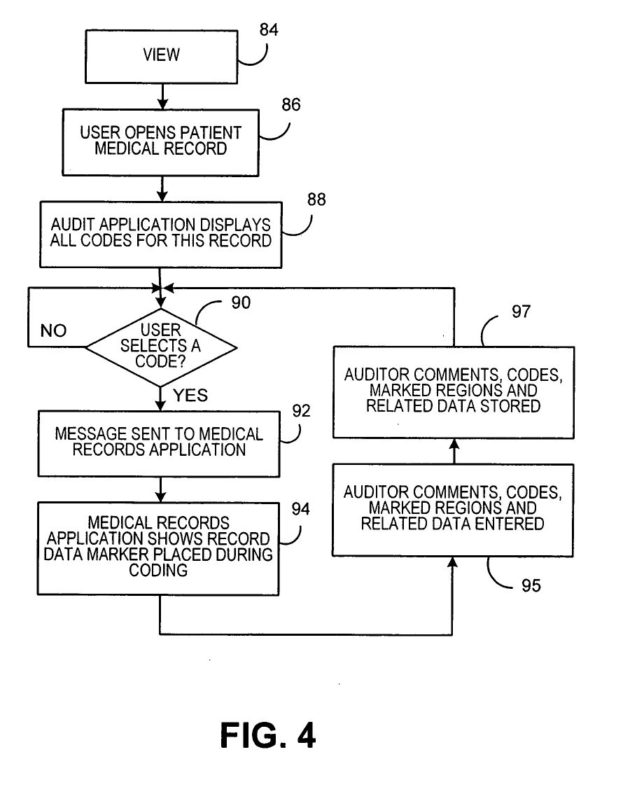

Reference is now made to FIG. 4, where a code can be tracked to the original content in the medical record associated with the code assignment and allows the user to step through the medical record. The process begins at 84, where the user opens a patient medical record at 86. The audit application displays all codes for the particular record at 88. Thus, the various codes originally entered into the record or entered at any subsequent time are all displayed, if desired, for the particular medical record being processed. A determination is made at 90 whether the user selects a particular code. If the user does not select a particular code, the system loops back to the input to decision block 90. However, if a code is selected at 90, a message is sent the medical records application at 92. The medical records application 12 shows the medical record data marker placed during the coding for the particular codes selected at 94. The system then proceeds to block 95 where audit action and other information may be entered and to block 97 where auditor action and other information is stored and then returns to decision block 90, where the user can select a different code for processing. The system employs the medical record application 12 at 86, the audit application 16 at 88, 90 and 92, and the medical records application 12 again at 94.

The message sent to the medical record at 92 enables the particular portion of the medical record associated with the selected code to be displayed for review by the auditor depending whether the VIEW button 60 or HIDE button 62 has been activated. The auditor may agree or disagree with a particular code selection for the portion displayed. At block 95, the system can provide for the auditor to make note of the agreement or disagreement, to make note of different codes that may be selected, or codes that may be deleted, and/or an explanation for the action taken. In this way, the subsequent re-auditing process, should that occur, allows for a further refinement of the coding and auditing of the particular medical record being processed. The system has thus allowed the coding and storing of audit trail information to facilitate subsequent audits and to enhance the effectiveness of the coding of medical records and the subsequent auditing of those records. The audit information (comments, deleted codes, added codes and the like as well as auditor data such as time stamp, auditor identification, digital signature are at 97 entered and loaded into the database. The system then returns to the input to decision box 90.

In operation, the coder reviews the medical record. When the coder finds the critical passages in the patient documentation, they can capture the codes in a coding system. This puts a visible marking onto the imaged or electronic medical record. The coder moves the flag to exact location of the source documentation that supports the code and attaches it by clicking, drag and drop or other computer interaction. If the coder needs to visibly mark multiple passages from the document, they can get additional flags or other forms of marking for a code by instantiating additional marking and placing them in the pertinent locations. Multiple code marking for a passage may be noted such as by a superscript number and stored for subsequent retrieval with the visibly marked medical record region.

While the medical record is presented to the coder in electronic form, the electronic form can be an imaged medical record, or can be a database electronic medical record data. Paper aspects of the medical records can be scanned and stored as electronic medical records where desired so as to be available for use with the system.

When the coder makes the coding keystrokes, the coding software captures the codes and a flag or mark would appear in the view of the imaging or digital medical record system. The coder moves the flag to the data or region of the imaged medical record that substantiates the assigned code. These flag locations (data references), the actual medical code assigned, and possibly other aspects of the coders activity such as time stamps and coder identification, are stored in the database of the medical record.

Placing the mark or flag in the digital medical record or imaged medical record can be done by enabling the coder to click and drag a screen cursor over a region to highlight a passage, click on a specific datum, and/or place a flag near or on a region for association. Any method can be employed that makes it plain which data or region of the medical record is to substantiate the medical code assigned. The imaged or digital medical record system allows any data or any region of any image to be flagged by a coder. Where necessary, existing imaged or digital medical record system can be modified to provide this functionality. The coder and/or auditor can mark overlapping but different regions of a medical record with multiple codes assigned if desired.

The information of the code, the flag, the region size, its location on the page, and/or other meta data, is be stored with the image in the image record database and become part of the permanent medical record storage. If desired, a digital signature of the coder and/or auditor can be also employed. This is analogous to the placement of a physician's digital signature near a passage that was transcribed or documented without the legally required authorizing handwritten signature.

When the audit of a medical record takes place, the medical record can reveal to the audit coder where in the medical record the substantiating evidence for a code is located. For instance, by selecting a code, the digital medical data or imaged medical record region flagged by the original coder would be brought into view. If multiple locations were indicated a list of links would be provided and the auditor could examine each or as desired as necessary due to regulation or procedure. The auditing process could thus be done, for example, on specific codes, over a great number of records, without the need to review each record in its entirety. The full coding of a record could be reviewed without needing to read the entire medical record.

When the auditor recodes the medical record, the audit coder may choose to operate the system in different modes of operation. The audit coder may choose to turn off the display of the coder's document flags until the system or auditor determines if there is a disparity in the coding assignment. The audit coder may then choose to turn on the flags to understand what the first coder was looking at when the first coder assigned codes. This mode of operation of the system can be also utilized as a training tool. In this utilization as a training tool the student can code a series of exercises or examination medical records, already coded by an expert or instructor. When the student has completed the coding, they can reveal the expert coding, as well as see where in the medical record the expert or instructor coder found the supporting documentation for the assignment of the codes. When utilized in the audit mode, the auditor might also turn on the coders flags and review a number of similar records, to see what documentation is referenced for the assignment of the same or similar codes in each chart.

While the present invention has been disclosed and described with reference to a single embodiment thereof, it will be apparent, as noted above, that variations and modifications may be made therein. It is, thus, intended in the following claims to cover each variation and modification that falls within the true spirit and scope of the present invention.

What is claimed is:

1. A method of processing medical records, comprising the steps of:
providing an image of a medical record on a screen;
inputting a code associated with a portion of said medical record;
selecting a first region of said medical record that supports said code;
visibly marking said selected first region of said medical record; and,
storing and associating for subsequent retrieval said code and said selected first region of said medical record.

2. A method of processing medical records as defined in claim 1 wherein said code is a medical diagnosis code and said selected first visibly marked region of said medical record is a region that supports said medical diagnosis code.

3. A method of processing medical records as defined in claim 1 wherein said code is a medical procedure code and said selected first visibly marked region of said medical record is a region that supports said medical procedure code.

4. A method of processing medical records as defined in claim 1 further comprising the steps of: opening said medical record; and, displaying said code associated with said medical record.

5. A method of processing medical records as defined in claim 4 further comprising the step of displaying said stored selected visibly marked first region of said medical record associated with said code.

6. A method of processing medical records as defined in claim 1 further comprising the steps of: retrieving said store code; and, displaying only said stored visibly marked first region of said medical record.

7. A method of processing medical records as defined in claim 1 further comprising the steps of: auditing said stored code and said associated stored visibly marked first region of said medical record; and, entering and storing data related to said auditing.

8. A method of processing medical records as defined in claim 7 wherein said stored auditing data is associated with said stored code and said associated stored visibly marked first region of said medical record.

9. A method of processing medical records as defined in claim 7 wherein said stored auditing data is a second code which is different from said code.

10. A method of processing medical records as defined in claim 7 wherein said stored auditing data is a second visibly marked region of said medical record.

11. A method of processing medical records as defined in claim 7 wherein said stored auditing data is text material explaining said audit activity.

12. A method of processing medical records, comprising the steps of:
providing an image of a medical record on a screen;
inputting a plurality of codes each code being associated with a portion of said medical record;
selecting a plurality of regions of said medical record that supports each of said plurality of codes;
visibly marking each of said selected plurality of regions of said medical record; and,
storing and associating for subsequent retrieval each of said plurality of codes with at least one of said selected plurality of visibly marked regions of said medical record.

13. A method of processing medical records as defined in claim 12 further comprising the steps of: opening said medical record; and, displaying said plurality of codes associated with said medical record.

14. A method of processing medical records as defined in claim 13 further comprising the step of displaying said stored selected visibly marked plurality of regions of said medical record associated with each of said plurality of codes.

15. A method of processing medical records as defined in claim 12 further comprising the steps of: retrieving said stored plurality of codes; and, displaying only said stored visibly marked plurality of regions of said medical record associated with each of said plurality of codes.

17. A method of processing medical records as defined in claim 12 further comprising the steps of: auditing said stored plurality of codes and said associated stored visibly marked plurality of regions of said medical record; and, entering and storing data related to said auditing.

18. A method of processing medical records as defined in claim 17 wherein said stored auditing data includes at least one code associated with at least one of said plurality of visibly marked regions which is different from a code previously associated with said one of said plurality of visibly marked regions.

19. A method of processing medical records as defined in claim 17 wherein said stored auditing data includes at least one visibly marked region of said medical record which is associated with at least one of said previously stored codes, and is different from said one of said plurality of visibly marked regions previously associated with said one of said previously stored codes.

20. A method of processing medical records as defined in claim 17 wherein said stored auditing data is text material explaining said audit activity.

21. A medical records coding and audit system comprising:
a computing system having a medical records application, a coding application and an audit application;
said computing system further including a medical records database, a captured codes database and an audit trail database;
a display coupled to said computing system for displaying medical records, displaying coding capture fields; and;
said medical records application, said coding application, said audit application, said medical records database, said captured codes database and said audit trail database operably connected to enable regions of a medical record displayed on said display to be visibly marked and associated with an entered code in said coding capture fields and stored for subsequent retrieval in said computing system.

22. A medical records coding and audit system as defined in claim 21 wherein said medical records application is connected to said medical records database, said a coding application is connected to said captured codes database and said audit application is connected to said audit trail database.

23. A medical records coding and audit system as defined in claim 22 wherein said coding application is connected to said audit application and said audit application is connected to said medical records application.
